(19) United States
(12) Patent Application Publication
(10) Pub. No.: US 2006/0234780 A1
(43) Pub. Date: Oct. 19, 2006

(54) Speakerphone with detachable ear bud

(76) Inventors: Martin H. Ramsden, Lawrenceville, GA (US); Ryan P. Rye, Lawrenceville, GA (US)

Correspondence Address: MOTOROLA INC, 600 NORTH US HIGHWAY 45, ROOM AS437, LIBERTYVILLE, IL, 60048-5343, US

(21) Appl. No.: 11/109,054

(22) Filed: Apr. 19, 2005

(51) Int. Cl. H04M 1/00

(52) U.S. Cl. 455/569.1

(57) ABSTRACT

This invention is a wireless, speakerphone accessory that allows the user to be in either public or private communication with a remote electronic device like a mobile telephone. The accessory includes a detachable ear bud that can be worn in a user's ear so that only the user hears the audio signal being received. When the ear bud is coupled to the speakerphone accessory, the circuitry in the ear bud is used to control a loudspeaker and other components in the accessory so as to convert the combined device in to a speakerphone that may be heard by the user and others in his immediate vicinity. The speakerphone accessory optionally includes pockets for receiving rechargeable batteries, as well as utility pockets for holding spare components like ear sleeves. The invention not only offers the dual functionality of private and public operating modes, but serves as a self-retaining case to greatly reduce the chances that any of the components become lost.

### TECHNICAL FIELD

This invention relates generally acoustic accessories for portable electronic devices, and more specifically to a wireless speakerphone accessory having a detachable ear bud that may be used for privately communicating with an electronic device like a telephone or radio.

### BACKGROUND ART

Mobile telephones are becoming more and more popular. Once a luxury item for the elite, it seems today that everyone carries a mobile phone to stay “connected” with the world. Even in rural areas, where land line service has yet to be established, many have bypassed the land-line technology by opting for a mobile telephone instead. Today's modern telephones include advanced features such as video cameras, speaker phone capability and wireless connectivity with both other devices and the World Wide Web.

As the popularity of the mobile telephone has flourished, so too has the popularity of accessories for the mobile telephone. While some users may opt for the basic phone, many users purchase additional accessories to increase there connectivity, including vanity covers, wireless headsets, desktop chargers and vehicular accessories. Indeed, while it used to seem odd to see someone talking aloud into thin air, today one must look closely before declaring the talker to be a crazy person. The person may in fact have a blue light blinking by his ear, indicating that he is talking to a remote caller by way of a wireless headset that communicates to a mobile phone in his pocket.

The problem with the accessories currently available on the market is twofold: First, when a user buys multiple accessories, he has multiple devices to keep up with. For example, if the user has a wireless headset and a hard-wired loudspeaker, these devices just constitute two more things that he must lug around. As anyone who juggles multiple things knows, the more things you carry around, the easier it is to lose one.

Next, not every accessory is suited to every application. One might purchase a hard-wired loudspeaker so that he can talk on the telephone without having to hold the telephone against his head. However, if he commutes to work on the New York subway system, he may not want a hundred strangers eavesdropping in on his conversation. In such a situation, his speakerphone accessory does him no good. He needs a private headset. His only option is to purchase multiple accessories for multiple environments.

There is thus a need for an improved accessory for mobile devices that reduces the probability of losing its components and is versatile in different operating environments.

### BRIEF DESCRIPTION OF THE DRAWINGS

FIG. 1 illustrates one embodiment of an ear bud in accordance with the invention.

FIGS. 2A and 2B illustrate one embodiment of a sleeve in accordance with the invention.

FIG. 3 illustrates one embodiment of an ear bud coupled to the sleeve of FIGS. 2A and 2B in accordance with the invention.

FIG. 4 illustrates one embodiment of an ear bud with a removable, rechargeable battery in accordance with the invention.

FIG. 5 illustrates one embodiment of a user interface in accordance with the invention.

FIG. 7 illustrates one embodiment of a speakerphone accessory in accordance with the invention.

FIG. 8 illustrates an exploded view of a speakerphone accessory and ear bud in accordance with the invention.

FIG. 9 illustrates an open, complete device in accordance with the invention.

FIG. 10 illustrates one embodiment of a complete device having a visor/belt clip in accordance with the invention.

FIG. 11 illustrates one embodiment of a schematic block diagram of a speakerphone accessory in accordance with the invention.

FIG. 12 illustrates one embodiment of a schematic block diagram of an ear bud in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention is a speaker phone accessory with a detachable ear bud. The ear bud, which can be selectively coupled to the accessory, allows a user to engage in a private call where the incoming audio cannot be heard by others. When the ear bud is coupled to the accessory, the resulting complete device allows the user to engage in a public call where the incoming audio can be heard by the user and others in the near vicinity. In one embodiment, the ear bud and speaker phone accessory use common, interchangeable, rechargeable batteries. The accessory allows the ear bud, spare batteries, and other accessories to be stored within the accessory, thereby reducing the probability that any one component will be lost.

The speakerphone accessory, with the ear bud coupled thereto, is capable of wirelessly communicating with an electronic device like a mobile telephone or two-way radio. The accessory, which is made from a top portion and a bottom portion that are hinged together to form a clam shell, includes a loudspeaker in one portion for broadcasting audible signals. The other portion of the clamshell has a pocket for accommodating the selectively detachable ear bud. When the ear bud is coupled to the accessory, the circuitry and user interface of the ear bud is used to control the operation of the loudspeaker.

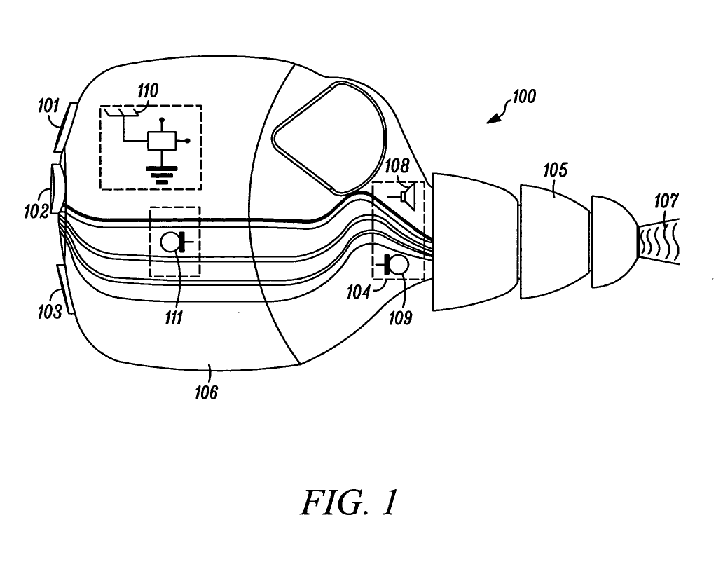

Turning now to FIG. 1, illustrated therein is one preferred embodiment of an ear bud 100 in accordance with the invention. The ear bud 100 is an earphone unit that may be mounted in the auditory tube of a user. It is referred to herein as a “bud” in that it is substantially smaller that most commercially available earphone units. In one embodiment, the body 106 of the ear bud measures less than 28 mm in height and 12 mm in width.

The ear bud 100 includes a speech reproducing transducer 108, or loudspeaker, that projects audible sound waves 107 into the auditory tube of the user. The loudspeaker 108 is positioned in the nozzle 104 of the ear bud 100. The nozzle 104 is a hollow, cylindrical protrusion that projects distally from the body 106 of the ear bud 100. It is the nozzle 104 that facilitates and directs the acoustic energy which translates from the ear bud 100 into the user's auditory tube. A sleeve 105, for example the triple flanged sleeve shown in FIG. 1, may be attached to the nozzle 104 so as to comfortably retain the ear bud 100 in a variety of differently shaped auditory tubes.

A speech registering microphone 111 is disposed within the ear bud 100 to detect the user's speech. In one embodiment, the microphone 111 is disposed along the body 106 of the ear bud 100 such that it can perform a “dual function” as a microphone for both the speakerphone accessory (when the ear bud 100 is coupled to the accessory) and the ear bud 100. While this dual functionality will be explained in more detail below, it is sufficient for now to know that the microphone 111 in the ear bud 100 can be used both when the ear bud 100 is disposed in the user's ear and when the ear bud 100 is coupled to the speakerphone accessory. To achieve efficient and optimal sound detection in the latter embodiment, it is desirable to locate the microphone 111 along the body 106 of the housing.

To increase the resolution of speech detection when the ear bud is in the ear, an alternate microphone 109 may either be placed in the nozzle 104 of the ear bud 100 so as to detect the speech of the user from the auditory tube as is known in the art. It will be clear to one of ordinary skill in the art having the benefit of this disclosure that other equivalent embodiments, like replacing microphones 111 and 109 with a single, remote microphone coupled to the ear bud 100 via a wire would work equally well.

Where the alternate microphone 109 disposed in the nozzle 104 is employed so as to detect the user's voice from the auditory tube, there are a variety of ways to situate the alternate microphone 109 and loudspeaker 108, since they are effectively collocated. For example, the alternate microphone 109 and loudspeaker 108 may be placed side by side. Next, the alternate microphone 109 and loudspeaker 108 may be placed in line along the acoustical axis of the nozzle 104, with the alternate microphone 109, which may be supported on struts, disposed centrally and in front of the loudspeaker 108. Another option is to employ a dynamic transducer which is a device having one diaphragm that is capable of simultaneously detecting and reproducing sound. Other equivalents will be obvious to those of ordinary skill in the art who have the benefit of this disclosure.

Where the embodiment having the microphone 109 and loudspeaker 108 both disposed in the nozzle 104 of the ear bud 100 is employed, there will be occasions where both the loudspeaker 108 is reproducing sound and the user is talking. In these situations, noise canceling firmware running on a microprocessor or digital signal processor disposed within the ear bud 100 will need to remove the reproduced sound from the sound detected by the alternate microphone 109. One simple way to do this is through digital signal processing. As the circuitry inside the ear bud 100 knows what the loudspeaker 108 is producing, by virtue of the received audio signal, the circuitry inside the ear bud 100 may simply perform Fourier transformations on both the signal being produced by the loudspeaker 108 and the signal being detected by the alternate microphone 109. A simple subtraction of the signal being produced by the loudspeaker 108 from the signal being detected by the microphone yields the speech being generated by the user.

The exterior housing of the ear bud 100 is preferably manufactured from a rigid plastic material like polycarbonate, ABS or polycarbonate-ABS by way of an injection molding process. The body 106 of the ear bud 100 contains electrical circuitry, which may include battery charging circuitry, wireless transceiver circuitry and audio conversion/amplification circuitry. This circuitry is controlled by a user interface disposed on the body 106 of the ear bud 100. By way of example, in FIG. 1, a plurality of buttons 101-103 may be used to control operational characteristics like answering calls, disconnecting calls, increasing and decreasing volume and turning the device on or off.

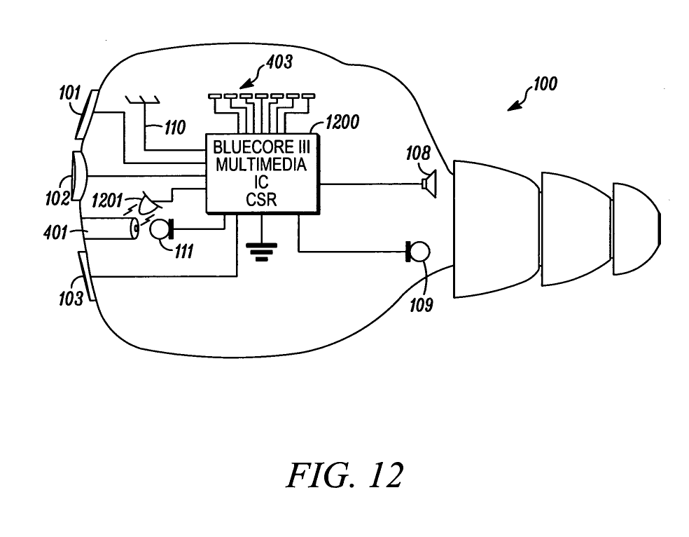

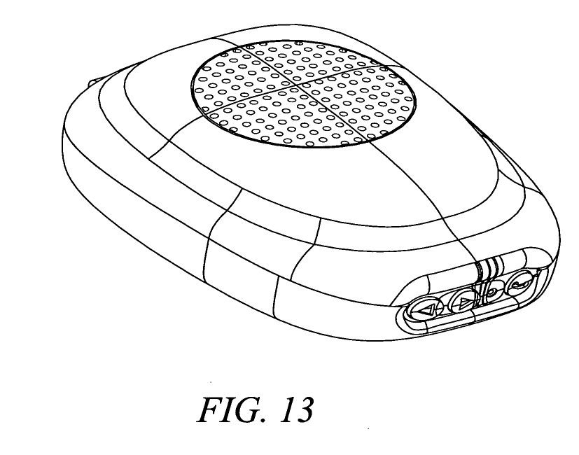

The ear bud 100 includes a transceiver 110 for wirelessly communicating with an electronic device. Local area wireless communication devices and protocols, like Bluetooth, Zigbee and Wi-Fi devices, may be employed to wirelessly communicate with a mobile device. A more complete schematic diagram will be discussed below referring to FIG. 12.

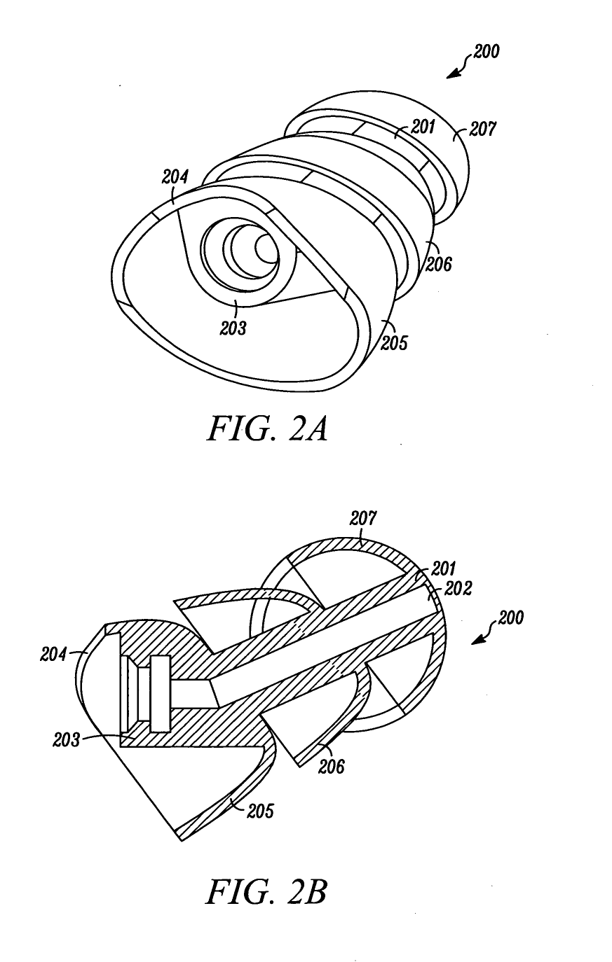

Turning now to FIGS. 2A and 2B, illustrated therein is an improved sleeve 200 in accordance with the invention. Recall from FIG. 1 that the nozzle 104 was a cylindrical, hollow protrusion that guides acoustic energy from the ear bud 100 to the user's auditory tube. The nozzle 104 projects generally at an angle that is normal with the body 106 of the ear bud 100, in that the ear bud's designer knows not how the user prefers to position the ear bud 100 within the ear. To facilitate a wide variety of possible positions, one embodiment of the invention employs the sleeve 200 of FIGS. 2A and 2B.

The sleeve 200, which may be manufactured from a slightly squishy, yet resilient material like silicone by way of an injection molding or compression molding process, includes a central member 201 having a lumen 202 through which acoustic energy may be directed in the embodiment of FIGS. 2A and 2B, the central member 201 and lumen 202 include a bend which, when viewed in cross section, comprises an angle of between 15 and 75 degrees. When passing through the sleeve, acoustic energy effectively makes a “turn” around this bend.

A nozzle gasket 203 is disposed about the lumen where the sleeve 200 couples to the nozzle 104. The nozzle gasket 203 effectively forms a high-friction coupling into which the nozzle 104 may be inserted. The nozzle gasket 203 keeps the sleeve 200 reliably coupled to the nozzle 104.

Three flanges 205,206,207 are disposed about the central member 201. These three flanges 205-207 ensure that the sleeve 200, and thus the attached ear bud 100, stay securely positioned within the user's auditory tube. The flanges 205-207, which may be hemispherical, are generally curved so as to be easily inserted in to the ear. The rear portion of the flanges 205-207 frictionally couple to the inside of the auditory tube. In one preferred embodiment, flange 207 is hemispherical in shape, while flanges 205 and 206 are parabolic. Experimental results have shown that a parabola satisfying the equation y=xˆ2 works well for flange 206, while a parabola satisfying the equation y=xˆ4 works well for flange 205.

As the shape of the nozzle may not be exactly cylindrical, a curved cut-out 204 is included in flange 205. The curved cut-out 204 prevents interference between the body 106 of the ear bud 100 and flange 205. Sleeve 200 is intended to allow the user to couple the sleeve 200 to the ear bud 100 and then rotate the sleeve 200 so as to find the position and angle that is most comfortable to the user. As such, the curved cut-out 204 ensures that the user may position the sleeve 200 at any angle he chooses.

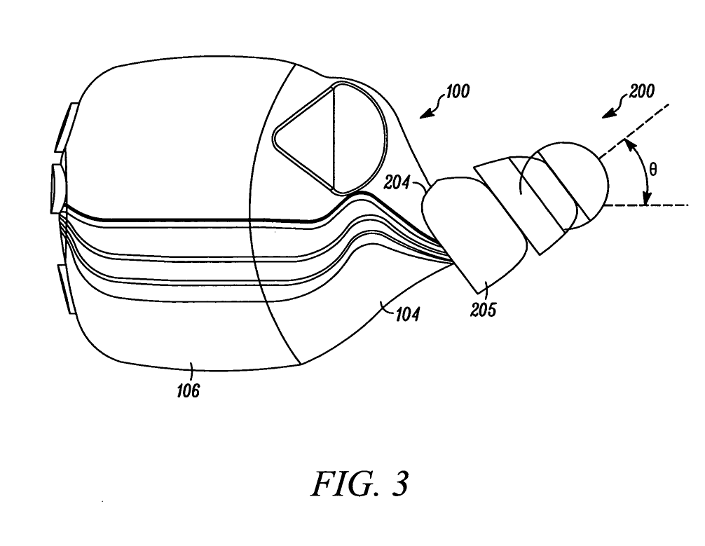

Turning now to FIG. 3, illustrated therein is the sleeve 200 of FIGS. 2A and 2B coupled to the ear bud 100. Notice that when the nozzle gasket (not visible in this particular view) is coupled to the nozzle 204, the bend causes the sleeve 200 to project outward from the body 106 of the ear bud at an angle 30°. The curved cut-out 204 prevents mechanical interference from occurring between the body 106 of the ear bud 100 and flange 205. As the user rotates the sleeve 200, the bend allows the sleeve 200 to be positioned at a variety of angles with respect to the ear bud 100.

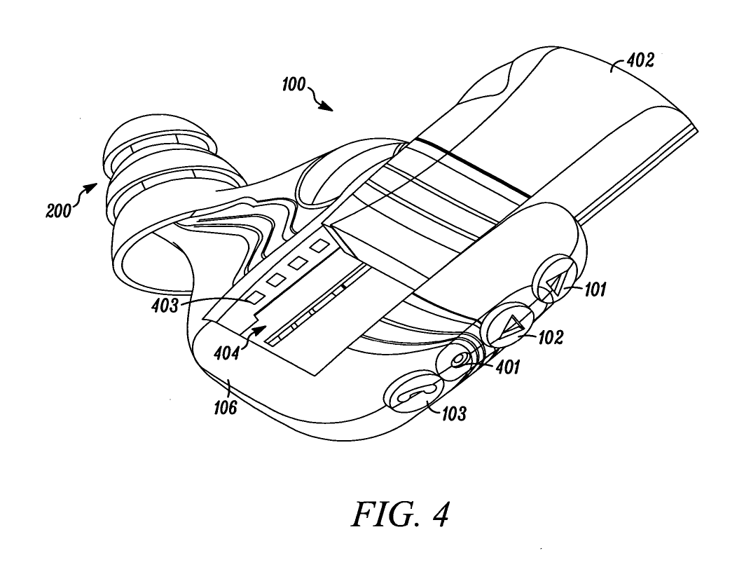

Turning now to FIG. 4, illustrated therein is an alternate view of an ear bud 100 in accordance with the invention. From this angle, the buttons 101-103, as are the sleeve 200 and nozzle 104, are more easily seen. Additionally, the port 401 for microphone 111 is also visible.

As mentioned above, the ear bud 100 includes internal circuitry for receiving and transmitting information, as well as for modulating/amplifying the audio signals. This circuitry, of course, requires energy for operation. The energy is supplied by a battery pack 402, which couples to the body 106 of the ear bud 100. The battery pack 402 may be either a rechargeable battery or a primary, single-use battery.

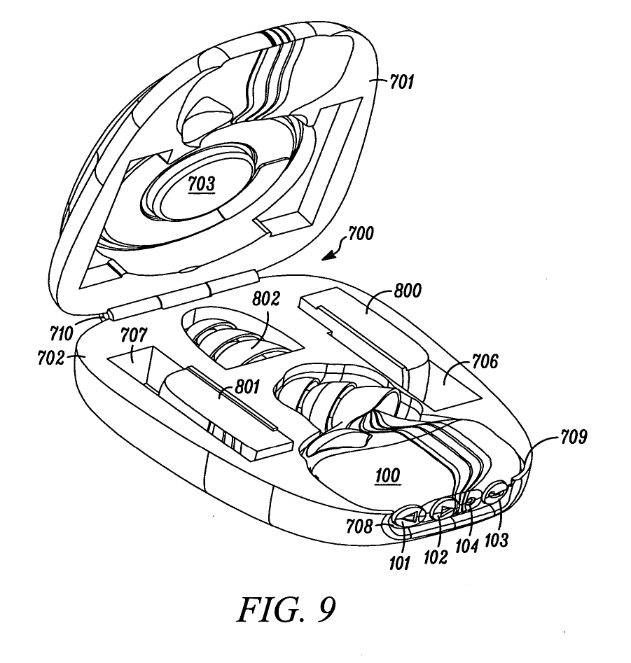

A pocket 404, having electrical contacts 403 disposed therein, is provided for receiving the battery pack 402 and coupling the cells disposed within the battery pack 402 to the circuitry disposed within the ear bud 100. A mechanical latch (not shown) may be included to keep the battery pack 402 securely retained within the pocket 404. The electrical contacts 403 are used for coupling the ear bud 100 to the speakerphone accessory as will be seen in FIG. 9. The electrical contacts 403 are capable of conducting data and information in addition to energy.

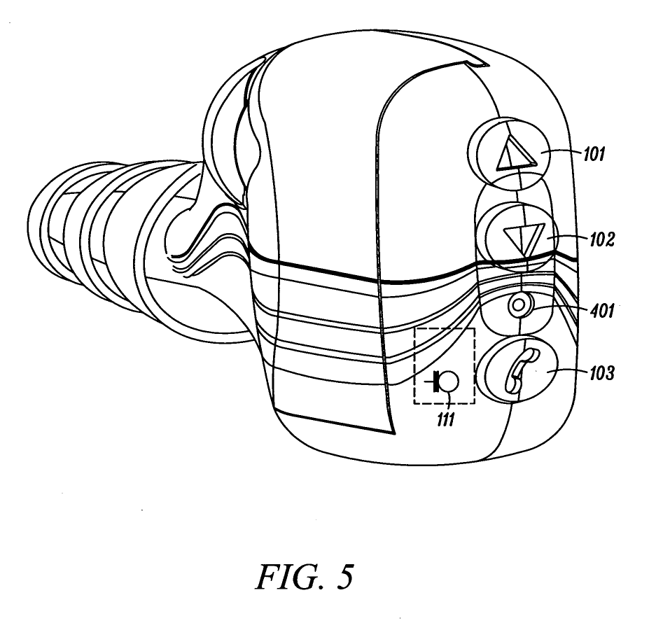

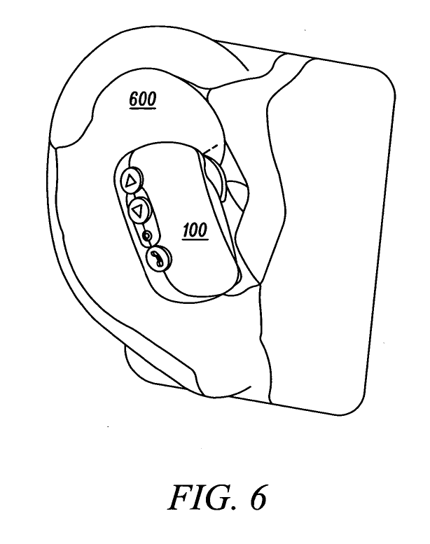

Turning now to FIG. 5, the user interface may be more easily seen. The user interface comprises a plurality of buttons 101-103 and ports, e.g. 401, that a user may use to control the ear bud 100. While any number of buttons may be used for the user interface, one preferred embodiment employs three buttons 101 -103 as the user interface. A first button 101 is used to increase the volume of the internal loudspeaker (element 108 of FIG. 1). A second button 102 is used to decrease the volume of the internal loudspeaker 108.

A third button 103, referred to as a multi-function button, is used to control multiple functions of the ear bud 100. For example, if the ear bud 100 is being used as a wireless, hands free accessory for a mobile phone, when an incoming call is detected, the user may press the multi-function button 103 to answer the call. Similarly, when the user has completed the call, the user may press the multi-function button 103 to release the call.

The multi-function button 103 may also be used to control other features of the ear bud 100 depending upon the length of time the multifunction button 103 is depressed, and the state of the electronic device. Continuing with the wireless, hands free accessory for a mobile phone from above, in one preferred embodiment, an extended press of the multifunction button may control the following functions: when the device is not in a call, an extended press of the multifunction button may cause the phone to redial the last number called; when the device is in a call, an extended press of the multifunction button may place the call on hold; and when the device currently has a call in progress, and another call is received, an extended press of the multifunction button may cause the phone to toggle between calls.

A port 401 is provided for the microphone 111 (FIG. 1) that is disposed along the body 106 of the ear bud 100. This port 401 allows the microphone 111 to detect acoustic energy from the air. In one preferred embodiment, this port 401 is a circular aperture filled with a cylindrical piece of plastic having a central lumen. The lumen provides an open pathway for the sound and acoustic energy in the air to reach the microphone. The cylindrical piece of plastic, which is preferably clear, may be used as a light pipe to direct light from an indicator light emitting diode (LED) which provides the user with an indication of the state of the ear bud 100. For example, when the ear bud 100 is communicating with the electronic device, the LED may blink. Similarly, when the battery in the ear bud 100 is being charged, the LED may illuminate continuously.

Turning now to FIG. 12, illustrated therein is one preferred embodiment of a schematic diagram for an ear bud 100 in accordance with the invention. As noted above, the ear bud 100 includes a microphone 111, a loudspeaker 108 and an optional microphone 109 for private use. Additionally, the ear bud 100 includes transceiver circuitry 110 for wirelessly communicating with an external electronic device. An indicator LED 1201 may also be included for indicating the operating state of the ear bud 100 as mentioned in the preceding paragraph.

All of these devices may be controlled by an application specific integrated circuit (ASIC) that is designed for wireless devices. For example, if the wireless protocol being employed is Bluetooth, several integrated circuit manufactures make ASIC Bluetooth controllers. One such controller, which is well suited to the ear bud 100 of this invention, is the Bluecore III multi-media controller 1200 manufactured by Cambridge Silicon Radio. This controller 1200 not only includes the transceiver driver for wireless communication, but audio amplifiers for the microphones 109,111 and loudspeaker, as well as indicator drivers for the LED 1201. Data and power are delivered to the controller 1200 by a set of electrical contacts 403.

Turning now to FIG. 6, illustrated therein is the ear bud 100 the nozzle and sleeve (not visible here) have been inserted into the auditory tube of the user's ear 600. If the angular sleeve of FIGS. 2A and 2B is employed, the user may rotate the sleeve so that the ear bud 100 rests in the outer ear in a comfortable position. As shown in FIG. 6, the user has easy access to the interface buttons 101-103 even when the device is inserted into the ear 600.

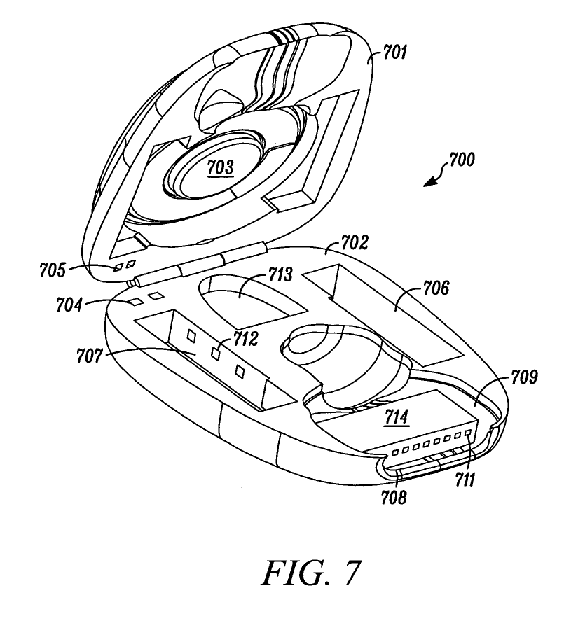

Now that the ear bud 100 is more clearly understood, the following paragraphs will examine the speakerphone accessory. Turning now to FIG. 7, illustrated therein is one preferred embodiment of a speakerphone accessory 700 in accordance with the invention. The accessory 700, which may be constructed from plastic by way of an injection molding process, includes a top portion 701 and a bottom portion 702 that may be hinged together 710 so as to form a clam shell. The top portion 701 has a loudspeaker 703 disposed therein. This loudspeaker 703 is used when the accessory 700 is in speakerphone mode.

The bottom portion 702 of the accessory 700 includes an ear bud pocket 709 into which the ear bud 100 may be inserted. Recall that one of the advantages of this invention is that it keeps things together, so that the probability of losing an accessory part decreases. Another advantage is the “dual use” functionality of the overall accessory for both private and public listening capability. (Note that as used herein, private mode, private use or private call refer to communications where the incoming audio may only be heard by the user. Public mode, public call or public use refers to a mode of operation where the incoming audio is broadcast by a loudspeaker such that it can be heard by both the user and others in the user's immediate vicinity.) In one embodiment, when the ear bud 100 is inserted into the pocket 709 of the speakerphone accessory, the combined unit employs a microphone 111 in the ear bud 100 to detect the user's voice. A microphone designed to detect voice from the auditory tube (e.g. 109) is not well suited for detecting acoustical energy from the air due to the fact that the nozzle 104 is generally small, with a narrow lumen. As such, to take advantage of the dual functionality, the bottom portion 702 includes an aperture 708 through which the ear bud 100, and thus the port 401 for microphone 111, may protrude. This aperture 708 allows the microphone 111 to detect the user's voice when the ear bud 100 is coupled to the speakerphone accessory 700.

The aperture 708 additionally allows the plurality of buttons 101-103 disposed along the body 106 of the ear bud 100 to be used to control the speakerphone accessory 700. Electrical contacts 711 disposed within the ear bud pocket 709 couple to the electrical contacts 403 on the ear bud 100 when the ear bud 100 is placed in the ear bud pocket 709. These electrical contacts 711 allow the circuitry within the ear bud 100 to control the loudspeaker 703 and other circuits of the speakerphone accessory 700. For example, when the ear bud 100 is placed in the ear bud pocket 709, volume buttons 101 and 102 may be used to control the volume of loudspeaker 703.

To keep the ear bud 100 aesthetically pleasing, the electrical contacts 403 in the ear bud 100 are used to couple to the speakerphone accessory 700 so that no external electrical contacts need exist on the body 106 of the ear bud 100. As such, the pocket 709 of the speakerphone accessory 700 includes a battery shaped protrusion 714 having the electrical contacts 711 disposed thereon. When the battery 402 of the ear bud 100 is removed, the ear bud 100 may be inserted into the pocket 709 such that the electrical contacts 715 in the pocket 709 couple to the electrical contacts 403 in the ear bud 100. The battery shaped protrusion 714 also helps to keep the ear bud 100 securely positioned within the pocket 709.

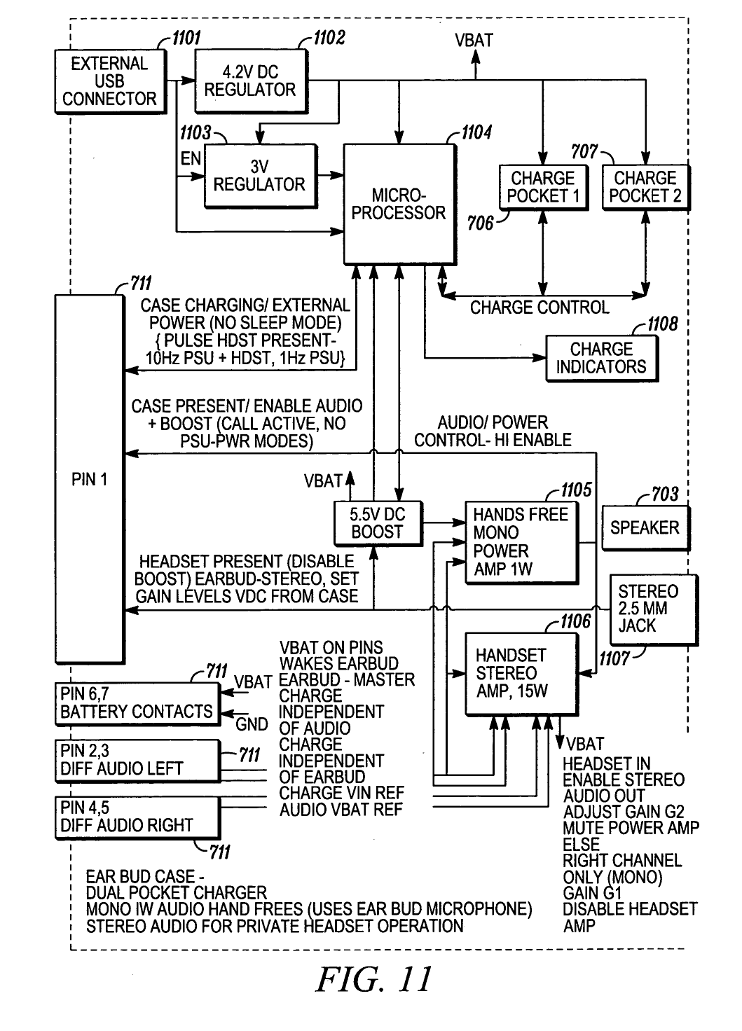

The speakerphone accessory additionally includes other pockets 706,707,713. Pockets 706 and 707 are for receiving rechargeable battery packs to power the circuitry that will be discussed in FIG. 11. In one preferred embodiment, the pockets 706-707 are designed to receive battery packs that are the same as the battery pack 402 that the ear bud 100 uses. As such, the user has access a spare battery pack at all times, as the one coupled to the ear bud 100 (e.g. battery 402) may reside in pocket 707, while a spare is stored in the pockets 706. The pockets 706-707 include electrical contacts, e.g. 712. These electrical contacts 712 are used to both power the speakerphone accessory 700 and recharge batteries stored in the pockets 706-707 as well.

Other utility pockets 713 may be included also. For example, in one preferred embodiment, pocket 713 may be used to store a spare sleeve. If sleeve 200 were to become lost or damaged, the user would have a spare at his fingertips.

Electrical power may be transferred from the bottom portion 702 to the top portion 701 in a variety of ways. There may, for example, be a permanent, conductive connection that runs from the bottom portion 702 to the top portion 701 through the hinged joint 710. Optionally, there may be complimentary electrical contacts 704-705 that engage each other when the clam shell created by the bottom portion 702 and top portion 701 are closed.

Turning now to FIG. 11, illustrated therein is one preferred embodiment of a schematic block diagram for a speakerphone accessory 700 in accordance with the invention. Some of the externally viewable components, like the electrical connections 711 that couple to the ear bud 100 and the battery pockets 706-707 were mentioned in the preceding paragraphs. These components are linked with an electrical circuit which may be constructed on a printed circuit board or flexible circuit substrate that is disposed within the speakerphone accessory 700.

An external connector 1101 is used for transferring both power and data to the device. Power is used to charge both the battery 402 coupled to the ear bud 100 and the pair of batteries disposed in the pockets 706-707. Data may be used to transfer firmware code, revision updates and other information to either the microprocessor 1104 in the speakerphone accessory 700 or to the ear bud 100. One suitable connector for this application is a USB or mini-USB connector, as it is an industry standard connector having both power and data terminals.

Power coupled to the external connector 1101 is then regulated to suitable levels depending upon the application in the speakerphone accessory 700. For example, if the battery packs stored within the pockets 706-707 are lithium-based batteries, it may be desirable to regulate the incoming power to 4.2 V with regulator 1102 to ensure proper charging. If the other circuit components, for instance the microprocessor 1104, need other operating voltages, a second voltage regulator 1103 may additionally be included.

The microprocessor 1104 serves as the brain of the speakerphone accessory 700. It coordinates and facilitates not only battery charging, but data communication between ear bud 100 and other components as well. The microprocessor 1104, in conjunction with its associated memory, may ramp, step, taper and otherwise modulate the voltage and current being delivered to the pockets 706-707 for charging the batteries. Additionally, the microprocessor may actuate charging indicators 1108, like LEDs for example, to alter the user to the charging status of the batteries.

Information is conveyed to the microprocessor through the electrical contacts 711. These contacts tell the microprocessor 1104, for example, whether the ear bud 100 is coupled to the speakerphone accessory 700. They also alert the microprocessor 1104 as to the charge status of the battery 402 coupled to the ear bud 100, whether a call is present, in addition to other information. The electrical contacts 711 may also pass stereo audio signals from the ear bud 100 to an optional stereo jack 1107 in the speakerphone accessory. Amplifiers 1105,1106 may amplify or otherwise modulate these audio signals to ensure proper volume levels.

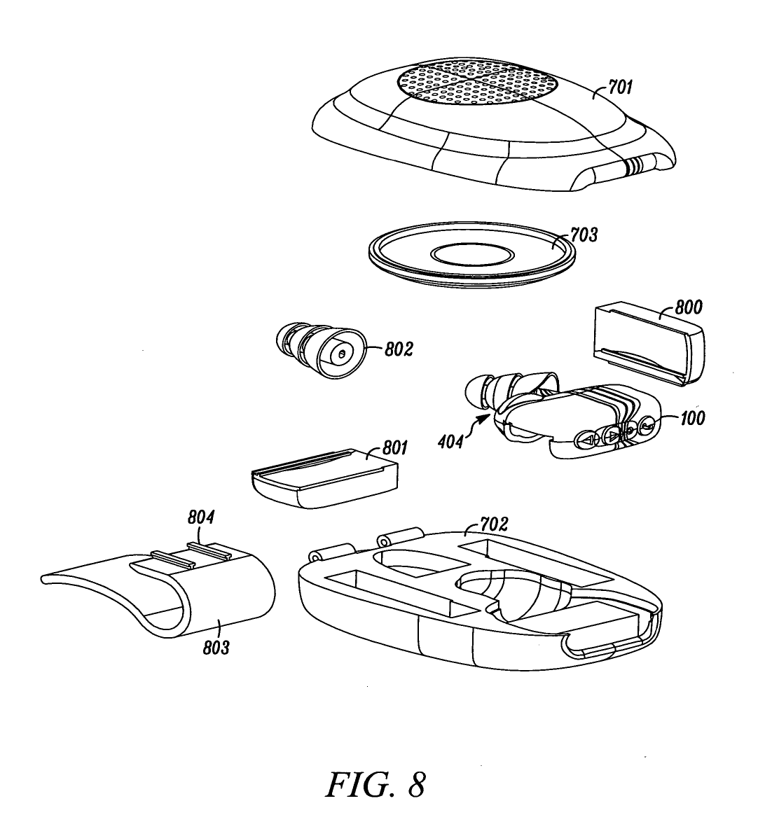

Turning now to FIG. 8, illustrated therein is an exploded view of the major components of the overall accessory in accordance with the invention. In FIG. 8, the main components of the speakerphone accessory 700 are shown, including the upper portion 701, the lower portion 702 and the main speakerphone loudspeaker 703. The detachable components, including the ear bud 100, a spare sleeve 802 and spare batteries 800-801 are also shown.

Some users may prefer to use the ear bud 100 in the ear when walking about, yet prefer to use the speakerphone accessory 700 when in their car. For this reason, an optional belt/visor clip 803 can be provided. The belt/visor clip 803, with mechanical coupling rails 804 may be attached to the back of the bottom portion 702 of the speakerphone accessory 700 so that it may be coupled to either the visor of a car or a belt.

Turning now to FIG. 9, illustrated therein is a completed device, or completed accessory, in accordance with the invention. The accessory is completed because the ear bud 100 has been coupled to the speakerphone accessory 700 so as to form a fully functional, wireless communication device. The batteries 800,801 have been inserted into the battery pockets 706-707. Note that in this exemplary embodiment, the pockets 706-707 are longer in length than are the batteries 800-801. This is so that the batteries 800-801 may be placed in the pockets 706-707 and then moved slightly laterally into a locked position.

The upper portion 701 has been coupled to the lower portion 702 at the hinge 710. The loudspeaker 703 has been set into position in the upper portion 701, and the spare sleeve 802 has been placed in the utility pocket 709. The ear bud 100 has been placed in the ear bud pocket 709. Notice that the plurality of buttons 101-103, in addition to the microphone port 104, are exposed through the aperture 708 in the bottom portion 702. As noted above, this exposure allows the microphone 111 in the ear bud 100 to serve as the microphone for the overall accessory. It also allows the buttons 101-103 to control the speakerphone accessory 700. The completed device, when the clam shell is closed, is illustrated in FIG. 13.

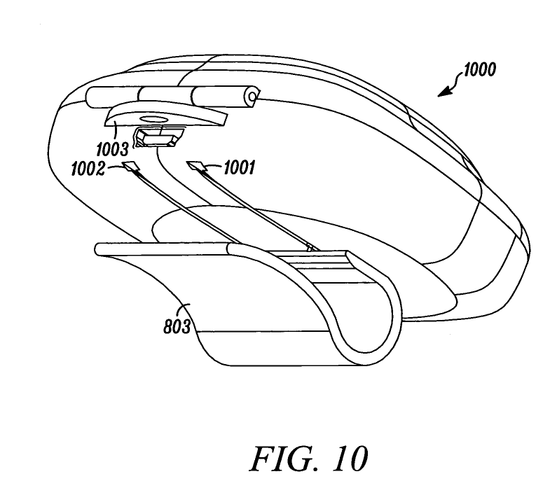

Turning now to FIG. 10, illustrated therein is the completed device 1000. In FIG. 10, various coupling mechanisms can be seen. Recall from the discussion of FIG. 8 that some users may wish to clip the device 1000 to the visor of a car. To accommodate this functionality, the visor clip 803 has been coupled to the device 1000 by sliding the mechanical coupling rails 803 into coupling slots 1001-1002 to lock the clip 803 onto the device 1000.

Other users may prefer to wear the device 1000 around their neck when using it as a speakerphone. To accommodate this functionality, an optional lanyard clip 1003 may be included so as to allow the user to insert a lanyard and wear the device as a necklace.

To summarize the invention, a wireless speakerphone accessory is provided. The accessory has a first loudspeaker disposed within the upper portion of the accessory. The accessory also includes a selectively detachable ear bud. The ear bud has a loudspeaker and at least one microphone.

When the ear bud is decoupled from the speakerphone accessory, the user may insert the ear bud into his ear for private communication. When the ear bud is coupled to the accessory, the audio signal received by the transceiver circuit of the ear bud is coupled form the ear bud to the loudspeaker in the accessory so that the accessory may be used for public communication. This audio signal is coupled to the accessory loudspeaker when a set of electrical contacts disposed within the accessory couple to a set of electrical contacts disposed along the ear bud. Where an optional stereo jack is present, for example for a set of head phones, the audio signal may also be coupled to the stereo jack.

A plurality of buttons control the ear bud, when decoupled from the accessory, and the overall device, when the ear bud is coupled to the accessory. These buttons may control a variety of functions, including volume of the applicable loudspeaker. For example, when the ear bud is decoupled from the accessory, the buttons may control the volume of the loudspeaker disposed within the ear bud. When the ear bud is coupled to the accessory, the loudspeaker within the ear bud may be disabled, as the ear bud is now capable of controlling the loudspeaker disposed within the accessory. In these situations, the buttons may control the volume of the loudspeaker in the accessory. The buttons are exposed through an aperture in the accessory when the ear bud is coupled to the accessory.

In one preferred embodiment, the speakerphone accessory includes pockets for receiving a rechargeable battery. Where the rechargeable batteries are of the same size and specifications as the battery that couples to the ear bud, the user has back up batteries fully charged and ready to go in the event that the battery coupled to the ear bud dies. Power is delivered to these batteries by way of a power connector, like a mini-USB connector for example, that is coupled to the exterior of the accessory. Charging circuitry for properly charging the batteries may be coupled serially between the power connector and the pockets.

In one embodiment, the accessory is made from a top portion and a bottom portion. These portions are hinged together so as to form a clam shell enclosure. Various components, including a spare ear sleeve and spare batteries, may be placed within the clam shell. As such, the accessory not only allows the user to participate in both private and public conversations, but reduces the chance that any one component will be lost.

The ear bud includes a transceiver circuit that allows either the ear bud, when decoupled from the accessory, or the completed device, when the ear bud is coupled to the accessory, to receive wireless communication from a remote electronic device. Examples of such devices include land-line telephones, computers, mobile telephones, radios and MP3 players.

The ear bud, when decoupled from the device, projects sound into the user's auditory tube through a nozzle. An ear sleeve may be coupled to the nozzle so as to allow the ear bud to fit comfortably and securely within the user's ear. In one preferred embodiment, to allow maximum flexibility, the ear sleeve includes a bend. The bend allows the sleeve to be rotated about the nozzle to change the projection angle. The projection angle may be anywhere between 15 and 75 degrees from the nozzle. In one embodiment the angle is between 30 and 60 degrees.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A wireless speakerphone accessory, comprising:
a. a first loudspeaker disposed within the accessory; and
b. a detachable ear bud comprising at least a second loudspeaker.

2. The accessory of claim 1, wherein the ear bud further comprises a microphone.

3. The accessory of claim 2, wherein when the ear bud is coupled to the accessory, an audio signal is selectively coupled from the ear bud to the first loudspeaker.

4. The accessory of claim 3, wherein when the ear bud is coupled to the accessory, a first set of electrical contacts disposed within the accessory electrically couple to a second set of electrical contacts disposed along the ear bud.

5. The accessory of claim 4, wherein the ear bud further comprises a plurality of buttons for controlling the operation of the ear bud.

6. The accessory of claim 5, wherein the plurality of buttons control at least the volume of the second loudspeaker.

7. The accessory of claim 6, wherein when the ear bud is coupled to the accessory, the plurality of buttons control at least the volume of the first loudspeaker.

8. The accessory of claim 7, wherein the accessory further comprises at least one pocket for receiving a rechargeable battery.

9. The accessory of claim 8, wherein the accessory further comprises at least one pocket for retaining a spare ear tip.

10. The accessory of claim 8, wherein the accessory further comprises a connector for receiving power.

11. The accessory of claim 10, wherein the accessory further comprises charging circuitry for properly charging the rechargeable battery.

12. The accessory of claim 3, wherein the accessory comprises a top portion and a bottom portion, wherein the top portion and bottom portion are hinged so as to form a clam shell.

13. The accessory of claim 3, wherein the ear bud comprises a transceiver for communicating wirelessly with a device selected from the group consisting of land-line telephones, computers, mobile telephones, radios and MP3 players.

14. The accessory of claim 1, wherein the ear bud comprises an ear tip, the ear tip, when coupled to the ear bud, projecting outward from the ear bud at an angle of between 30 and 60 degrees.

15. The accessory of claim 14, wherein the ear tip is rotatable with respect to the ear bud.

16. The accessory of claim 5, wherein the accessory comprises an aperture, wherein when the ear bud is coupled to the accessory, the plurality of buttons are exposed through the aperture.

17. The accessory of claim 1, further comprising a mounting clip coupled to the accessory.

18. A wireless accessory for communicating with an electronic device, the accessory comprising:
a. a first loudspeaker;
b. a selectively detachable ear bud, the ear bud comprising a microphone and a second loudspeaker;
c. a pocket for receiving the ear bud disposed within the accessory,
d. electrical contacts disposed within the pocket; and
e. electrical contacts disposed upon the ear bud;
wherein when the ear bud is placed within the pocket, the ear bud deactivates the second loudspeaker and selectively transmits an electronic signal to the first loudspeaker.

19. The accessory of claim 18, wherein both the accessory and the ear bud comprise a slot for receiving a rechargeable battery.

20. The accessory of claim 19, wherein the ear bud comprises a transceiver for communicating with a remote electronic device.
